(19) United States
(12) Patent Application Publication
(10) Pub. No.: US 2011/0144988 A1
(43) Pub. Date: Jun. 16, 2011

(54) EMBEDDED AUDITORY SYSTEM AND METHOD FOR PROCESSING VOICE SIGNAL

(76) Inventors: JongSuk Choi, Seoul (KR); Munsang Kim, Seoul (KR); Byung-Gi Lee, Seoul (KR); Hyung Soon Kim, Busan (KR); Nam Ik Cho, Seoul (KR)

(21) Appl. No.: 12/857,059

(22) Filed: Aug. 16, 2010

(30) Foreign Application Priority Data
Dec. 11, 2009 (KR) 10-2009-0123077

(51) Int. Cl. G10L 15/20

(52) U.S. Cl. 704/233; 704/E15.039

(57) ABSTRACT

An embedded auditory system includes a voice detecting unit for receiving a voice signal as an input and dividing the voice signal into a voice section and a non-voice section; a noise removing unit for removing a noise in the voice section of the voice signal using noise information in the non-voice section of the voice signal; and a keyword spotting unit for extracting a feature vector from the voice signal noise-removed by the noise removing unit and detecting a keyword from the voice section of the voice signal using the feature vector. A method for processing a voice signal includes receiving a voice signal as an input and dividing the voice signal into a voice section and a non-voice section; removing a noise in the voice section of the voice signal using noise information in the non-voice section of the voice signal; and extracting a feature vector from the voice signal noise-removed by the noise removing unit and detecting a keyword from the voice section of the voice signal using the feature vector.

### CROSS-REFERENCE TO RELATED APPLICATION

This application claims priority from and the benefit of Korean Patent Application No. 10-2009-123077, filed on Dec. 11, 2009, which is hereby incorporated by reference for all purposes as if fully set forth herein.

### BACKGROUND

1. Field of the Invention

Disclosed herein are an embedded auditory system and a method for processing a voice signal.

2. Description of the Related Art

An auditory system recognizes a sound produced by a user and localizes the sound so that an intelligent robot can effectively interact with the user.

Generally, techniques used in the auditory system includes a sound source localizing technique, a noise removing technique, a voice recognizing technique, and the like.

The sound source localizing technique is a technique for localizing a sound source by analyzing a signal difference between microphones in a multichannel microphone array. By using the sound source localizing technique, an intelligent robot can effectively interact with a user positioned at a place that is not observed with a vision camera.

The voice recognizing technique may be divided into a short-distance voice recognizing technique and a long-distance recognizing technique depending on the distance between a microphone array and a user. The current voice recognizing technique is much influenced by the signal to noise ratio (SNR). Therefore, an effective noise removing technique is required in the long-distance voice recognizing technique with a low SNR. Studies have been conducted to develop various kinds of noise removing techniques for increasing voice recognition performance, such as beamformer filtering, adaptive filtering and Wiener filtering techniques. Among these noise removing techniques, it is known that the multichannel Wiener filtering technique has an excellent performance.

A keyword spotting technique is one of voice recognizing techniques, which spots a keyword from a natural, continuous speech. An existing isolated-word recognizing technique has an inconvenience of pronunciation in which a word to be recognized is necessarily syllabled, and an existing continuous-speech recognizing technique has a relatively lower performance than the existing isolated-word recognizing technique. The keyword spotting technique has been proposed as a technique for solving such problems of the existing voice recognizing techniques.

Meanwhile, an existing auditory system is operated in a main system of a robot on the basis of PCs, or is operated by configuring a separate PC. When the auditory system is operated in the main system of the robot, the amount of calculation in the auditory system may impose a heavy burden on the main system. Also, since it is necessary to perform a tuning process between programs for the purpose of effective communication with the main system, it is difficult to apply the auditory system to robots with various types of platforms. When the auditory system is operated by configuring a separate PC, cost for configuring the separate PC is increased, and the volume of the robot is increased.

### SUMMARY OF THE INVENTION

Disclosed herein are an embedded auditory system and a method for processing a voice signal, which can be applied to various types of robots that are energy efficient and inexpensive by modularizing auditory functions necessary for an intelligent robot into a single embedded system completely independent without relying on a main system.

In one embodiment, there is provided an embedded auditory system including: a voice detecting unit for receiving a voice signal as an input and dividing the voice signal into a voice section and a non-voice section; a noise removing unit for removing a noise in the voice section of the voice signal using noise information from the non-voice section of the voice signal; and a keyword spotting unit for extracting a feature vector from the voice signal noise-removed by the noise removing unit and detecting a keyword from the voice section of the voice signal using the feature vector.

The embedded auditory system may further include a sound source localizing unit for performing the localization of the voice signal in the voice section divided by the voice detecting unit.

In one embodiment, there is provided a method for processing a voice signal, the method including: receiving a voice signal as an input and dividing the voice signal into a voice section and a non-voice section; removing a noise in the voice section of the voice signal using noise information from the non-voice section of the voice signal; and extracting a feature vector from the voice signal noise-removed by the noise removing unit and detecting a keyword from the voice section of the voice signal using the feature vector.

The method may further include performing the localization of the voice signal in the voice section divided by the dividing of the voice signal into the voice and non-voice sections.

### BRIEF DESCRIPTION OF THE DRAWINGS

The above and other aspects, features and advantages disclosed herein will become apparent from the following description of preferred embodiments given in conjunction with the accompanying drawings, in which:

FIG. 1 is a block diagram showing an embedded auditory system according to an embodiment;

FIG. 2 is a diagram showing the arrangement of microphones constituting a three-channel microphone array according to the embodiment;

FIG. 3 is a flowchart illustrating the data processing of a sound source localizing unit according to the embodiment;

FIG. 4 is a flowchart illustrating the data processing of a noise removing unit according to the embodiment;

FIG. 5 is a flowchart illustrating the data processing of a keyword spotting unit according to the embodiment;

FIGS. 6A to 6C are graphs showing results obtained by performing fast Fourier transform (FFT) with respect to a rectangular wave signal using an FFT function provided in a library and then restoring it through inverse transformation;

FIG. 6D is a graph showing a result obtained by performing FFT using an FFT extending technique; and

FIG. 7 is a graph showing a transformation phase of an equi-spaced Hz-frequency into a mel-frequency.

### DETAILED DESCRIPTION OF THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

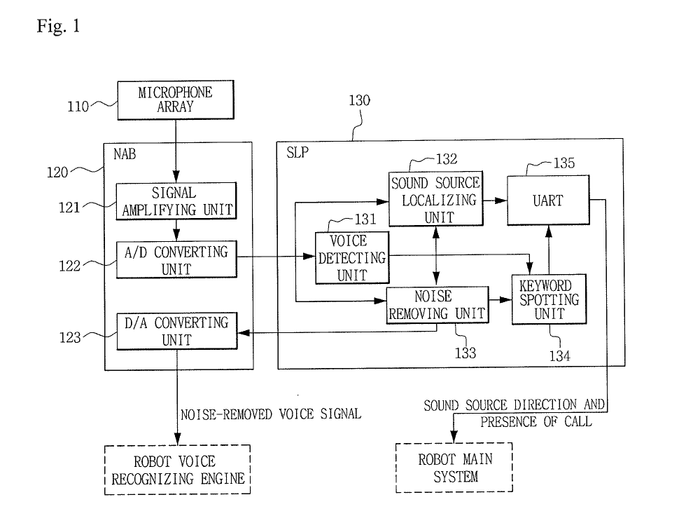

FIG. 1 is a block diagram showing an embedded auditory system according to an embodiment.

Referring to FIG. 1, the embedded auditory system according to the embodiment may be configured as a sound localization process (SLP) board 130. The SLP board 130 may be connected to a microphone array 110 for obtaining a long-distance voice signals and a non-linear amplifier board (NAB) 120 for processing analog signals.

The SLP board 130 may include a voice detecting unit 131, a sound source localizing unit 132, a noise removing unit 133 and a keyword spotting unit 134. The configuration of the SLP board 130 is provided only for illustrative purposes, and any one of units constituting the SLP board 130 may be omitted. For example, the SLP board 130 may include the voice detecting unit 131, the noise removing unit 133 and the keyword spotting unit 134, except the sound source localizing unit 132.

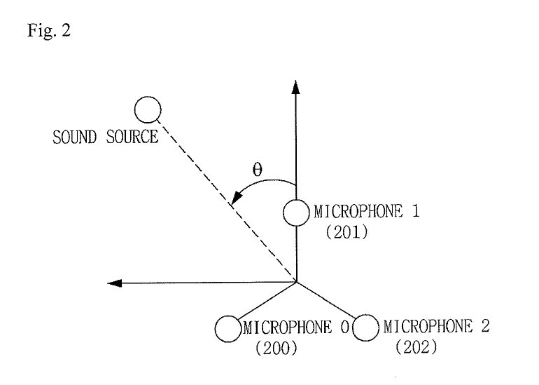

FIG. 2 is a diagram showing the arrangement of microphones constituting a three-channel microphone array according to the embodiment;

The microphone array 110 may be configured as a three-channel microphone array as shown in FIG. 2. The three-channel microphone array may include three microphones 210, 211 and 212 equally arranged at an interval of 120 degrees while drawing a circle with a radius of 7.5 cm. The arrangement of the microphones shown in FIG. 2 is provided only for illustrative purposes, and the number and arrangement of microphones may be variously selected depending on the user's requirements. Long-distance signals can be obtained through such microphones.

Referring back to FIG. 1, an analog signal obtained through the microphone array 110 is processed by the NAB 120. The NAB 120 may include a signal amplifying unit 121, an analog/digital (A/D) converting unit 122 and a digital/analog (D/A) converting unit 123. Generally, the analog signal obtained through the microphone array 110 is too weak to be processed, and hence, it is necessary to amplify the analog signal. The signal amplifying unit 121 amplifies the analog signal obtained through the microphone array 110. Since the SLP board 130 processes a digital signal, the A/D converting unit 122 converts the signal amplified by the signal amplifying unit 121 into a digital signal. The D/A converting unit 123 receives the digital signal processed by the SLP board 130. Particularly, the D/A converting unit 123 may receive a voice signal in which noise is removed by the noise removing unit 133.

A signal converted into the digital signal by the A/D converting unit 122 is transmitted to the SLP board 130 and then inputted to the voice detecting unit 131. The voice detecting unit 131 receives the signal converted into the digital signal as an input to divide the input signal into a voice section and a non-voice section. A signal indicating the voice or non-voice sections is shared in the entire auditory system to serve as a reference signal in response to which other units such as the sound source localizing unit 132 are operated. That is, the sound source localizing unit 132 performs localization only in the voice section, and the noise removing unit 133 removes noise in the voice section using noise information from the non-voice section.

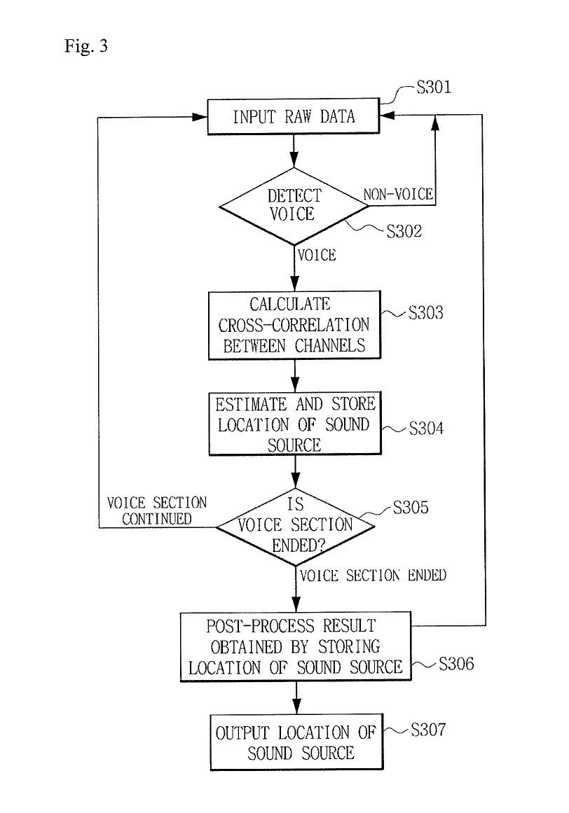

FIG. 3 is a flowchart illustrating the data processing of the sound source localizing unit according to the embodiment. In order to illustrate the flow of data in the voice and non-voice sections, the operation of the voice detecting unit is included in FIG. 3. The operation of the sound source localizing unit, illustrated in FIG. 3, is provided only for illustrative purposes, and may be performed differently or in a different order.

In the data processing of the sound source localizing unit, a raw data, i.e., a voice signal converted into a digital signal, is first inputted to the voice detecting unit (S301). The inputted raw data is divided into voice and non-voice sections by the voice detecting unit, and only the voice section is inputted to the sound source localizing unit (S302). The sound source localizing unit calculates a cross-correlation between microphone channels (S303) and then evaluates the delay time of the voice signal, which is taken to reach each microphone from a sound source, using the cross-correlation between the microphone channels. As a result, the sound source localizing unit estimates the location of a sound source with the highest probability and then stores the estimated location (S304). Then, it is determined whether or not the voice section is continuing (S305). If the voice section is continuing, the voice signal converted into a digital signal is again inputted to the voice detecting unit at the operation S301 to detect a voice, and the localization is then performed again. If the voice section is ended, the result obtained by storing the estimated locations of the sound source is post-processed (S306) and the location of the sound source is outputted (S307).

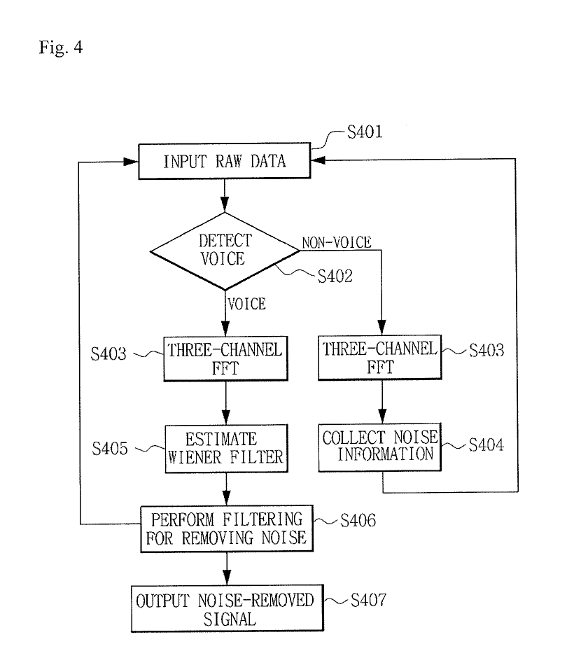

FIG. 4 is a flowchart illustrating the data processing of the noise removing unit according to the embodiment. In order to illustrate the flow of data in the voice and non-voice sections, the operation of the voice detecting unit is included in FIG. 4. The operation of the noise removing unit, illustrated in FIG. 4, is provided only for illustrative purposes, and may be performed differently or in a different order.

The noise removing unit may be a multichannel Wiener filter. The multichannel Wiener filter is designed based on the filter output and smoothness for a normal input in which a signal and a noise are mixed together or the minimum mean square error with a desired estimated output. In the processing of the multichannel Wiener filter, a raw data, i.e., a voice signal converted into a digital signal, is first inputted to the voice detecting unit (S401). The inputted raw data is divided into voice and non-voice sections by the voice detecting unit, and the voice and non-voice sections are inputted to the multichannel Wiener filter (S402). The multichannel Wiener filter performs fast Fourier transform (FFT) with respect to the voice signal so as to process the voice signal. As the result of the FFT, the voice signal is transformed from a time domain to a frequency domain. As the result of performing the FFT with respect to the non-voice section, noise information is collected, and the Wiener filter is estimated by performing the FFT with respect to the voice section (S405). Then, filtering for removing noise is performed with respect to the voice section using the noise information collected from the non-voice section (S406), and the noise-removed signal is outputted (S407).

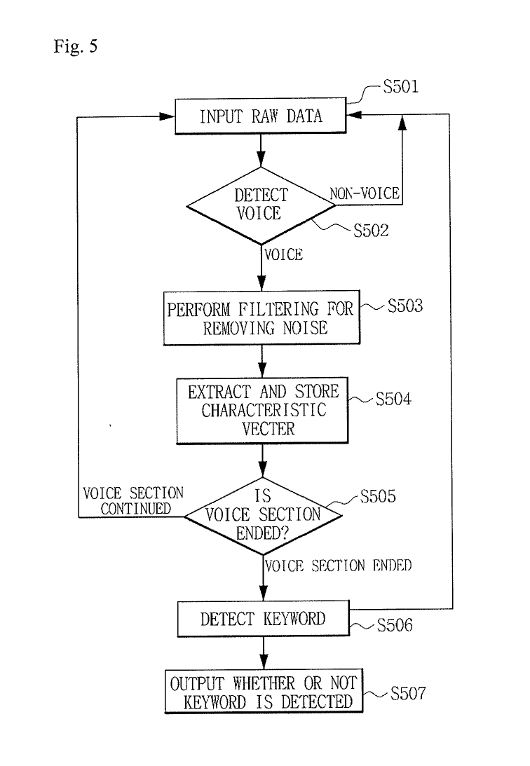

FIG. 5 is a flowchart illustrating the data processing of the keyword spotting unit according to the embodiment. In order to illustrate the flow of data in the voice and non-voice sections, the operations of the voice detecting unit and the noise removing unit are partially included in FIG. 5. The operation of the keyword spotting unit, illustrated in FIG. 5, is provided only for illustrative purposes, and may be performed differently or in a different order.

In the data processing of the keyword spotting unit, a raw data, i.e., a voice signal converted into a digital signal, is first inputted to the voice detecting unit (S501). The inputted raw data is divided into voice and non-voice sections by the voice detecting unit, and only the voice section is inputted to the noise removing unit (S502). The noise removing unit performs filtering for removing noise with the voice section (S503). The keyword spotting unit receives the noise-removed voice section as an input to extract and store a feature vector (S504). Then, it is determined whether or not the voice section is continuing (S505). If the voice section is continuing, the voice signal converted into a digital signal is again inputted to the voice detecting unit at the operation 5501 to detect a voice, and the noise removal and feature vector extraction are then performed again. If the voice section is ended, a keyword is detected (S506), and it is outputted whether or not the keyword is detected (S507).

Referring back to FIG. 1, a universal asynchronous receiver/transmitter (UART) 135 may be used as a sub-system of a computer for supporting serial communications. The computer processes data for each byte. However, when the data is transmitted to the exterior of the computer, it is necessary to convert data for each byte into data for each bit. The UART 135 converts transmitted byte data into a series of bit data. On the contrary, the UART 135 combines inputted bit data and converts the combined bit data into byte data. In this embodiment, the UART 135 may receive results of the sound source localizing unit and the keyword spotting unit and transmits the received results to an external robot system through serial communications. The UART 135 is an additional element for serial communications, and may be added, replaced or deleted as occasion demands.

The technique of the embedded auditory system according to the embodiment may include a process of transforming to embedded programming codes and optimizing them so that functions of the respective units can well performed in the embedded auditory system. Particularly, the technique of the embedded auditory system according to the embodiment may include an FFT extending technique and a mel-frequency standard filter sharing technique of the multichannel Wiener filter.

The FFT is a function most frequently used in voice signal processing. The FFT function is provided in an existing embedded programming library. In the FFT function provided in the existing embedded programming library, there occurs a phenomenon that an error is increased as the length of an input data is increased. Since a float point unit (FPU) is not used in a general embedded system, a fixed point operation is performed. The fixed point operation has a narrow range, and hence, many overflow errors occur. In the FFT function provided in a library, the least significant bit of an inputted numerical value are forcibly truncated so as to avoid such overflow errors. At this time, the number of the truncated bits is in proportion to the log of base 2 in the length of an inputted data. As a result, the error of the FFT is gradually increasing as the length of the inputted data is increasing.

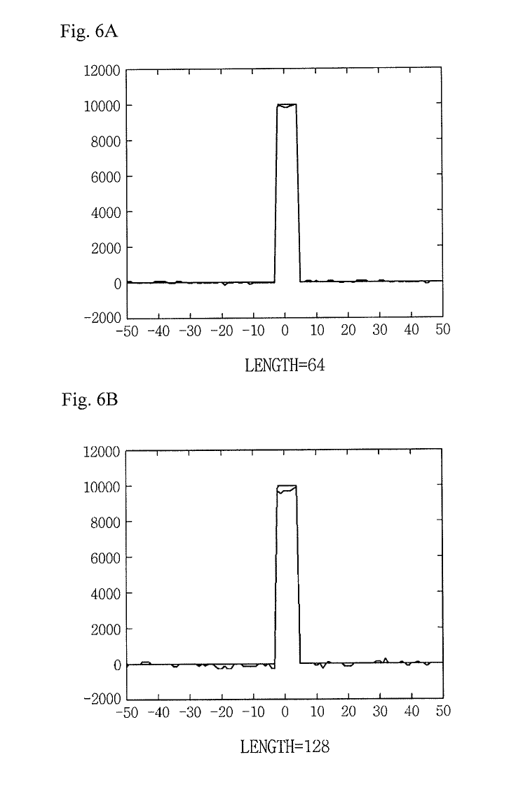

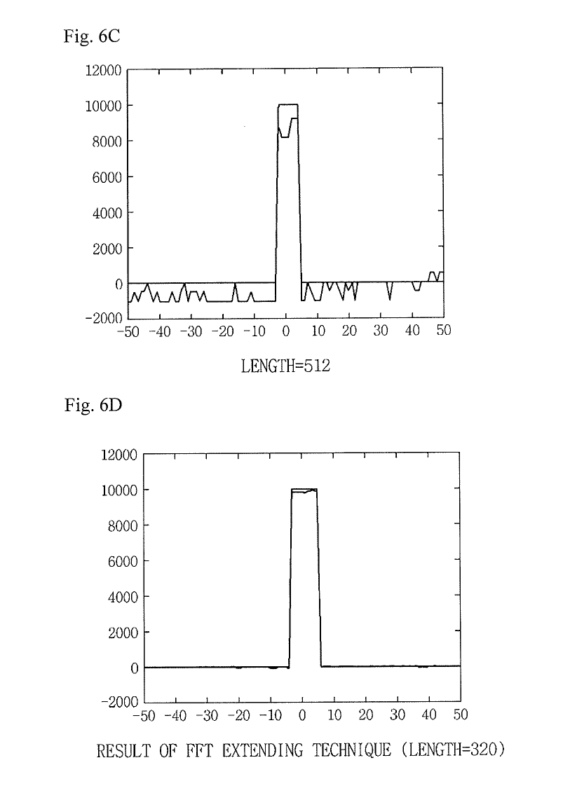

FIGS. 6A to 6C are graphs showing results obtained by performing FFT with respect to a rectangular wave signal using an FFT function provided in a library and then restoring it through inverse transformation. FIGS. 6A, 6B and 6C show results when the lengths of data in one frame are 64, 128 and 512, respectively.

Referring to FIGS. 6A to 6C, it can be seen that a restored signal is different from an original signal depending on the length of data. Accordingly, when the length of a data is longer than 64, the error of FFT becomes serious. As the length of the data is increasing, the error of the FFT is increasing.

In this embodiment, a data with a length of more than 64 is usually processed, and therefore, a method is required which can effectively perform FFT with respect to a data with a relatively long length while reducing the error of the FFT. To this end, the FFT extending technique has been proposed in this embodiment. The FFT extending technique is a technique for obtaining a second FFT result with a long length by through combination of a first FFT result with a short length. That is, when performing the FFT, a plurality of first FFT results is obtained by dividing a voice signal into a plurality of sections and then performing FFT with respect to the divided sections. Then, the second FFT result is obtained by adding up the plurality of first FFT results. Thus, the FFT extending technique is verified by the following equation 1.

$$\begin{matrix}\begin{matrix}{X}_{k} = {\sum }_{n = 0}^{MN - 1} {x}_{n} {e}^{- i \frac{2 π kn}{MN}} = {\sum }_{n = 0}^{N - 1} {\sum }_{m = 0}^{N - 1} {x}_{Mn + m} {e}^{- j \frac{2 π kn ( Mn + m}{MN}} \\ = {\sum }_{m = 0}^{M - 1} {\sum }_{n = 0}^{N - 1} {x}_{Mn + m} {e}^{- i \frac{2 π kn}{N}} {e}^{- \frac{2 π kn}{MN}} \\ = {\sum }_{m = 0}^{M - 1} {\hat{X}}_{k} {e}^{- \frac{2 π kn}{MN}}\end{matrix} & ( 1 ) \\ Here , {\hat{X}}_{k} = {\sum }_{n = 0}^{N - 1} {x}_{Mn + m} {e}^{- i \frac{2 π kn}{N}} . & \end{matrix}$$

According to Equation 1, when the length of a data is M×N, the FFT result with a length of M×N can be obtained through combination of M FFT results with a length of N. For example, when it is assumed that a FFT result with a length of 320 is necessary, the FFT result with the length of 320 can be performed through combination of five FFT results with a length of 64. FIG. 6D shows a result obtained by performing FFT through combination of five FFT results using the FFT extending technique. Referring to FIG. 6D, it can be seen that the FFT result with the length of 320 can be effectively performed almost without any error.

Meanwhile, the mel-frequency standard filter sharing technique of the multichannel Wiener filter has been proposed as a plan for reducing the amount of operation of the Wiener filter. The multichannel Wiener filter is an adaptive filter performed in a frequency domain. That is, filtering is performed by estimating a filter coefficient at which the noise removing effect is maximized for each frequency of the FFT every frame. It is assumed that the length of FFT used is 320. When positive and negative frequencies are identical to each other, a total of 161 FFT frequencies exist, and much operation amount is required in the process of estimating a total of 161 filter's coefficients. Such a large operation amount may impose a heavy burden on the embedded system that has a lower operational ability than the PC, and its operational speed may be lowered. Therefore, it is difficult to ensure the real-time performance of the embedded system.

In the mel-frequency standard filter sharing technique for solving such a problem, filter coefficients are not estimated at all frequencies but estimated at some frequencies, and the estimation result of the filter coefficients at adjacent frequencies is shared at frequencies that are not estimated, thereby reducing an operation amount. In the selection of a frequency shared by the filter, a method for standardizing a mel-frequency is used to minimize the degradation of performance caused by not performing estimation with respect to the filter at some frequencies. Unlike the Hz-frequency, the mel-frequency refers to a method for measuring a frequency based on the pitch scale felt by a human being. With such a property, the mel-frequency is a concept frequently applied to extract the feature vector of voice recognition. The transformation of the Hz-frequency to the mel-frequency is represented by the following equation 2.

m=1127.01048 ln(1+f/700) (2)

Here, f denotes a Hz-frequency, and m denotes a mel-frequency.

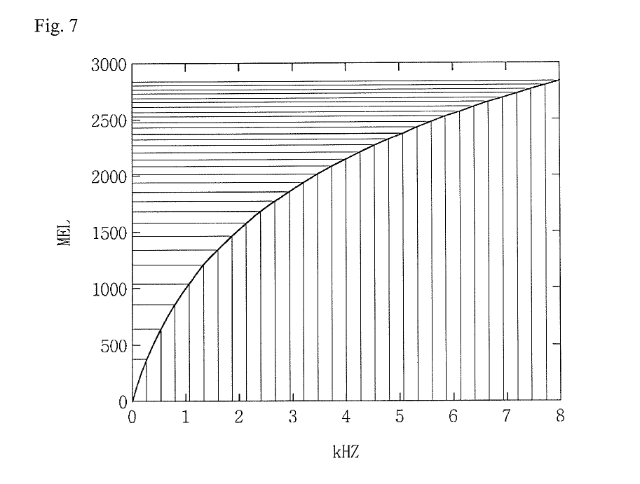

FIG. 7 is a graph showing a transformation phase of an equi-spaced Hz-frequency into a mel-frequency.

Referring to FIG. 7, the transformation phase according to Equation 2 can be observed. Accordingly, the mel-frequency does not correspond to the Hz-frequency linearly. The mel-frequency sparsely corresponds to the Hz-frequency in a low-frequency region but densely corresponds to the Hz-frequency in a high-frequency region. In the viewpoint of the mel-frequency, information in the low-frequency region is weaker than that in the high-frequency. For this reason, it is advantageous that a filter sharing frequency is more occupied in the high-frequency region than in the low-frequency region. Thus, in this embodiment, 40 filter sharing frequencies have been selected, and the degradation of performance can be minimized while reducing the operation amount of the multichannel Wiener filter.

The embedded auditory system and the method for processing a voice signal, disclosed herein, can modularize various auditory functions such as a sound source localizing function, a noise removing function and a keyword spotting function into a single embedded system, and can be applied to various types of robots that are energy efficient and inexpensive.

While the disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An embedded auditory system, comprising:
a voice detecting unit for receiving a voice signal as an input and dividing the voice signal into a voice section and a non-voice section;
a noise removing unit for removing a noise in the voice section of the voice signal using noise information in the non-voice section of the voice signal; and
a keyword spotting unit for extracting a feature vector from the voice signal noise-removed by the noise removing unit and detecting a keyword from the voice section of the voice signal using the feature vector.

2. The embedded auditory system according to claim 1, further comprising a sound source localizing unit for performing the localization of the voice signal in the voice section divided by the voice detecting unit.

3. The embedded auditory system according to claim 1, wherein, when performing fast Fourier transform (FFT) for transforming a voice signal from a time domain to a frequency domain, a plurality of first FFT results are obtained by dividing the voice signal into a plurality of sections and performing the FFT with respect to the divided sections, and a second FFT result is obtained by adding up the plurality of first FFT results.

4. The embedded auditory system according to claim 1, wherein the noise removing unit is a multichannel Wiener filter.

5. The embedded auditory system according to claim 4, wherein the multichannel Wiener filter uses a mel-frequency and removes a noise using a mel-frequency standard sharing technique in which filter coefficients are estimated at some frequencies, and the estimation result of filter coefficients at adjacent frequencies is shared at frequencies that are not estimated.

6. A method for processing a voice signal, the method comprising:
receiving a voice signal as an input and dividing the voice signal into a voice section and a non-voice section;
removing a noise in the voice section of the voice signal using noise information in the non-voice section of the voice signal; and
extracting a feature vector from the voice signal noise-removed by the noise removing unit and detecting a keyword from the voice section of the voice signal using the feature vector.

7. The method according to claim 6, further comprising performing the localization of the voice signal in the voice section divided by the dividing of the voice signal into the voice and non-voice sections.

8. The method according to claim 6, wherein, when performing FFT for transforming a voice signal from a time domain to a frequency domain, the removing of the noise comprises:
dividing the voice signal into a plurality of sections;
performing the FFT with respect to the divided sections, thereby obtaining a plurality of first FFT results; and
adding up the plurality of first FFT results, thereby obtaining a second FFT result.

9. The method according to claim 6, wherein the removing of the noise is performed through multichannel Wiener filtering.

10. The method according to claim 9, wherein the multichannel Wiener filtering uses a mel-frequency and removes a noise using a mel-frequency standard sharing technique in which filter coefficients are estimated at some frequencies, and the estimation result of filter coefficients at adjacent frequencies is shared at frequencies that are not estimated.
